(19) United States
(12) Patent Application Publication
(10) Pub. No.: US 2007/0017452 A1
(43) Pub. Date: Jan. 25, 2007

(54) Portable water bottle and dish assembly for humans and pets

(76) Inventors: Marni Markell Hurwitz, Far Hills, NJ (US); Ernest D. Buff, Far Hills, NJ (US)

Correspondence Address: ERNEST D. BUFF;ERNEST D. BUFF AND ASSOCIATES, LLC., 231 SOMERVILLE ROAD, BEDMINSTER, NJ, 07921, US

(21) Appl. No.: 11/487,094

(22) Filed: Jul. 14, 2006

Related U.S. Application Data
(63) Continuation-in-part of application No. 11/385,268, filed on Mar. 21, 2006.
Application No. 11/385,268 is a continuation-in-part of application No. 11/186,475, filed on Jul. 21, 2005.

(51) Int. Cl. A01K 7/00

(52) U.S. Cl. 119/74

(57) ABSTRACT

The present invention provides a portable water bottle and dish assembly and method for using same that provides a human or pet with a readily accessible water bottle disposed within a delivery dish. The portable water bottle and dish assembly broadly comprises a bottle having a top and body portions with an outer shell and an internal chamber that is removably attached and housed within a delivery dish. The delivery dish is configured in size and shape to provide access to a pet for drinking therefrom. Optionally, the bottle comprises an insulating internal chamber adapted to insulate liquid housed therein, keeping the liquid at a constant temperature for a period of time. Alternatively, the delivery dish comprises an insulating interior compartment adapted to insulate liquid. The present invention also provides a cup, wherein the bottle is disposed in the cup and both are integrally housed within the delivery dish.

### CROSS-REFERENCE TO RELATED APPLICATIONS

This application is a continuation-in-part of U.S. patent application Ser. No. 11/385,268, which was filed on Mar. 21, 2006, which in turn is a continuation-in-part of U.S. patent application Ser. No. 11/186,475, which was filed on Jul. 21, 2005, the disclosures of which are hereby incorporated by reference.

### BACKGROUND OF THE INVENTION

1. Field of the Invention

The present invention relates to a portable water bottle and dish assembly for humans and pets; and more particularly, to a water bottle having a dish removably attached thereto, the water bottle and/or dish being insulated, and thereby being especially well suited for use by humans and pets, respectively.

2. Description of the Prior Art Outdoor activities, especially in hot temperatures, require adequate hydration of pets, as well as pet owners. It is oftentimes difficult to provide adequate hydration to a pet, as the pet owner must either carry a dish or bowl, or attempt to deliver the water to the pet by pouring the water from a bottle into the pet's mouth or onto the absorbent ground. Inconvenience also can result when the pet owner becomes thirsty and must drink from the mouth of the water bottle, often times resulting in spillage or wetting due to condensation accumulation dripping from the bottle. It can be highly cumbersome and inconvenient to carry a water bottle, drinking cup, and a dish or bowl when performing outside activities, such as walking, jogging, or hiking. Water bottle's heretofore disclosed and utilized for humans and pets fail to provide a convenient, efficient manner in providing portable water bottles having a dish in close proximity thereto, and an efficient manner of filling the water dish by simply rotating the bottle. In addition, none of the water bottle's heretofore disclosed and utilized for humans and pets provide a convenient, efficient manner in providing portable water bottles having a dish and an optional cup in close proximity thereto. That is to say, none of the water bottles heretofore disclosed and utilized provides a portable assembly, wherein the water bottle is integrally housed within the water delivery dish so that the dish is conveniently available for providing optimal water consumption by a pet, and further appointed with an optional drinking cup integrally housed on the exterior of the water bottle for water consumption by the pet owner. Moreover, none of the water bottles heretofore disclosed and utilized provide an optional insulated water bottle or insulated water delivery cup and/or dish so that the water housed within the bottle can maintain a constant temperature for a given period of time, thereby, for example, providing a thirst quenching cool drink on a hot summer day in the middle of a forest during a hike.

For example, U.S. Pat. No. 5,687,783 to Finnegan discloses an animal watering device and method for automatically supplying pets with water as a large water vessel is connected to a drinking vessel. U.S. Pat. No. 5,884,582 to Duckworth discloses pet feeder for holding food and/or water dish for pets, adapted to help keep pets from scattering their food or splattering their drink out of their dishes. Also, U.S. Pat. No. 6,101,974 to Frohlich discloses a combination pet water bottle and bowl broadly comprising a molded plastic vessel capable of retaining water having a flat wall and a second wall having a bowl depression therein. However, none of these water delivery apparatuses can feasibly provide hydration while doing activities, as the water bottle and bowl combinations are not conceivably portable as the apparatuses would be too bulky and cumbersome to carry while walking. Moreover, the bowl portions are not integrally attached to the water bottle. None of these apparatuses provide for an insulated water bottle equipped with a dish assembly and/or with a drinking cup, and there is no indication that these apparatuses can be utilized by both a human and a pet. Lastly, none of these apparatuses can optionally include an attachment clip adapted to be attached to the waist of a person for easy transportability.

Even where portable water bottles having a delivery device, in the way of a cup or the like, have been heretofore disclosed and utilized, these portable water bottles fail to provide a water bottle integrally housed within an interior compartment of a dish or bowl so that the apparatus is compact in nature for effortless portability. For example, U.S. Pat. No. 4,530,439 to Finnell discloses a thermos bottle cap that doubles as a cup. While, U.S. Pat. No. 5,992,702 to Shapiro discloses a water bottle for pets and their owners broadly comprising a liquid container with a lid assembly having an opening through which a flexible tube extends and provides liquid to a liquid reservoir located on the top of the apparatus so that a pet can drink there from. In addition, U.S. Pat. No. 6,405,675 to Mills discloses a water bottle assembly having a removable water bowl for providing a receptacle for watering a pet while outdoors, broadly comprising a bottle, lid, and a bowl removably coupled to the water bottle for carrying the water bottle and bowl as a single unit. None of these water bottles and bowl assemblies provides a water bottle that is integrally housed within the interior compartment of the delivery bowl, rather these water bottle apparatuses provide a bowl attached to the top part or bottom of a water bottle. Moreover, these devices do not provide both a drinking cup for the pet owner and a drinking dish for the pet conveniently housed in close, integral proximity with a water bottle and one another. Additionally, the bottle does not rotate within the interstices of the dish, thereby providing a dish that has a configuration such as a trough so the pet can readily drink there from. Further, there is no indication that the bottle or dish is insulated to form a thermos to maintain and keep the temperature of the liquid constant for a period of time.

Although numerous insulated water bottles have been heretofore disclosed and utilized, none provide a water bottle integrally housed within the interior compartment of a delivery dish. Fore example, U.S. Pat. No. 5,094,363 to Monahan, et al., discloses an insulated water bottle adapted to be utilized for a bicycle. U.S. Pat. No. 6,604,649 to Campi discloses a container for the thermostatic preservation of liquids broadly comprising a shell having a cavity to accommodate a vessel which in turn houses a liquid container and encapsulates the liquid container with another top portion. Lastly, U.S. Pat. No. 6,401,964 to Goto, et al., discloses a portable insulating receptacle having an outer non-slip shell. None of these insulated water bottles provides a water bottle having a dish assembly wherein the water bottle is integrally housed within the interior compartment of the delivery bowl. In fact, these water bottles do not provide a receptacle for convenient delivery of the water/liquid to a human and pet so that the human and pet can readily drink there from.

Significantly, none of the water bottles heretofore disclosed and utilized provide a portable assembly, wherein the water bottle is integrally housed within the water delivery dish so that the dish is conveniently available for providing optimal water consumption for the pet owner and pet. Moreover, none of the water bottles heretofore disclosed and utilized provide an optional insulated water bottle or insulated water delivery dish. Such an optional insulation arrangement would allow the water housed within the bottle to maintain a constant temperature for a given period of time, thereby, for example, providing a thirst quenching cool drink on a hot summer day in the middle of a forest during a hike.

For the foregoing reasons, there exists a need in the art for a portable water bottle and dish assembly and method for humans and pets that provides a human and pet with a readily accessible water bottle integrally attached to a delivery dish. Also needed in the art is a portable water bottle and dish assembly that broadly comprises a bottle having a top portion and a body portion with an outer shell and an internal chamber that is removably attached and housed within a delivery dish. It would further be desirable if the delivery dish were configured in size and shape to provide access to a pet for drinking therefrom, and the bottle comprised an insulating internal chamber adapted to insulate the liquid housed therein, keeping the liquid at a constant temperature for a period of time. Also desirable, yet heretofore not available, is a delivery cup and/or delivery dish comprising an insulating interior adapted to insulate the liquid when the bottle is within the interior compartment of the delivery dish.

### SUMMARY OF THE INVENTION

The present invention provides a portable water bottle and dish assembly for humans and pets. The portable water bottle and dish assembly comprises a bottle removably housed within a delivery dish. The bottle includes a bottom portion, top portion equipped with a neck and an aperture, and a body portion having an outer shell and an internal chamber appointed for receiving and housing a liquid.

The delivery dish has an external casing and an interior compartment adapted to receive and removably house the bottle containing liquid. The delivery dish is further adapted to receive and contain the liquid so that the human and/or the pet can drink from the delivery dish after the bottle is removed therefrom. The top portion of the bottle has a bottle cap removably surrounding the aperture. The bottle cap is adapted to seal the aperture of the bottle so that the liquid housed therein does not escape out of the bottle. The bottle cap is connected to the neck of the top portion so that the bottle cap remains associated with the bottle when the bottle cap is removed from the aperture. In this way, the bottle cap cannot be misplaced or dropped, and is readily convenient for replacement onto the bottle.

The bottle may comprise insulation means adapted to insulate the liquid therein. Preferably, this is achieved by insulating the internal chamber of the bottle. Alternatively, the delivery dish comprises insulation means adapted to insulate the liquid housed in the bottle when the bottle is within the interior compartment of the delivery dish. Preferably, this is achieved by insulating the interior compartment of the delivery dish.

The body portion of the bottle may further comprise a locking portion adapted to secure the bottle in the interior compartment of the delivery dish. The locking portion comprises at least one concave locking arc. In this embodiment, the interior compartment of the delivery dish may further comprise at least one convex securing member adapted to be received by the concave locking arc of the body portion of the bottle. The concave locking arc and the convex securing member act in concert to secure the bottle within the interior compartment of the delivery dish. In addition, the body portion of the bottle may further comprise a release tab adapted to be utilized to release the body portion of the bottle from the interior compartment of the delivery dish.

Optionally, the delivery dish further comprises a fastening member adapted to secure the bottle in the interior compartment of the delivery dish. The fastening member of the delivery dish may comprise a fastening strap having a fastening means. The fastening means may be selected from the group consisting of hook and clasp closure, snap closure, loop closure, and Velcro closure.

The bottle cap may further comprises a pour spout adapted to open and close to provide access and seal the aperture of the bottle so that the liquid housed therein is accessible when the pour spout is open and the liquid does not escape out of the bottle when the pour spout is closed.

The interior compartment of the delivery dish may further comprise a cap receiving member having a receiving bottom, a watering slit and a receiving orifice. The receiving orifice has closure grooves located therein. The neck of the top portion of the bottle further comprises bottle top grooves fixedly surrounding the aperture. In addition, the aperture of the bottle has an aperture rim. The cap closure grooves, located within the receiving orifice, are adapted to removably receive the bottle top grooves and be twisted until the receiving bottom is in intimate contact with the aperture rim, thereby sealing the aperture of the bottle so that the liquid housed therein does not escape. Liquid is appointed to escape the bottle through the aperture and the watering slit into the delivery dish when the receiving bottom and the aperture rim are not in intimate contact.

An attachment clip may be included in the assembly. The attachment clip is located on the external casing of the delivery dish. Also, the outer shell of the bottle may further comprise a grip portion appointed for providing comfort to the human when holding the bottle. This grip portion may comprise a plurality of contour curves and can be composed of foam, sponge, plastic, or rubber material.

The portable water bottle and dish assembly may further comprise a cup having an outer surface, rim section, and a central compartment adapted to receive and removably house the bottom portion of the bottle. The cup is further adapted to receive and contain the liquid so that the human can drink therefrom. The bottle is disposed within the cup, and both are removably housed within the delivery dish. The cup may be composed of an insulating material so that the cup is adapted to insulate the liquid. The outer surface of the cup may include a cup grip.

In another embodiment, the portable water bottle and dish assembly for humans and pets comprises a bottle removably housed within a delivery dish appointed with a cap receiving member having a receiving orifice pivotally connected to a pivot means. The bottle comprises a bottom portion, a top portion having a neck and an aperture therein, and a body portion having an outer shell and an internal chamber appointed for receiving and housing a liquid. The delivery dish has an external casing and an interior compartment adapted to receive and removably house the bottle and further adapted to receive and contain the liquid so that the human and the pet can drink from the delivery dish after the bottle is removed therefrom. The interior compartment of the delivery dish comprises a cap receiving member having a receiving orifice pivotally connected to a pivot means. The cap receiving member includes a receiving bottom, a watering slit and a receiving orifice having cap closure grooves located therein. The neck of the top portion of the bottle further comprises bottle top grooves fixedly surrounding the aperture and the aperture of the bottle has an aperture rim. Cap closure grooves located within the receiving orifice are adapted to removably receive the bottle top grooves and be twisted until the receiving bottom is in intimate contact with the aperture rim thereby sealing the aperture so that liquid does not escape out of the bottle. Liquid is appointed to escape the bottle through the aperture and the watering slit into the delivery dish when the receiving bottom and the aperture rim are not in intimate contact.

In another embodiment, the portable water bottle and dish assembly for humans and pets comprises a bottle removably housed within a cup, wherein the bottle has insulation means. The bottle comprises a bottom portion, a top portion having a neck and an aperture therein, and a body portion having an outer shell and an internal chamber appointed for receiving and housing a liquid. A cup is provided. The cup has an outer surface, rim section, and a central compartment adapted to receive and removably house the bottom portion of the bottle and further adapted to receive and contain the liquid. An attachment clip is included. The attachment clip is located on the outer shell of the bottle. The top portion of the bottle is appointed with a bottle cap that removably surrounds the aperture and is adapted to seal the aperture of the bottle so that liquid housed therein does not escape.

The present invention also provides a method of delivering water by way of a portable water bottle and dish assembly to a pet or human. The method includes the first step of filling a bottle with a liquid, wherein the bottle comprises insulation means adapted to insulate the liquid and comprises a bottom portion and a top portion having a neck, an aperture, and a body portion having an outer shell and an internal chamber appointed for receiving and housing a liquid therein. The neck has bottle top grooves fixedly surrounding the aperture, and the aperture of the bottle has an aperture rim. A bottle cap is then placed on the top portion of the bottle. The bottle cap removably surrounds the aperture and is adapted to seal the aperture of the bottle so that the liquid housed therein does not escape. The bottle cap is connected to the neck of the top portion so that the bottle cap remains associated with the bottle when the bottle cap is removed from the aperture. The bottle appointed with the bottle cap is placed within an interior compartment of a delivery dish having a cap receiving member with a receiving bottom, a watering slit and a receiving orifice having cap closure grooves located therein.

The delivery dish, with the bottle containing the liquid housed therein, is then carried until the pet or human experiences thirst. The bottle is then removed from the interior compartment of the delivery dish, and, while the bottle is in an up-right position, the bottle cap is removed. The top portion of the bottle is placed within the receiving orifice of the cap receiving member of the interior compartment of the delivery dish so that the bottle top grooves and the cap closure grooves are in intimate contact and can be twisted together to unite the bottle with the delivery dish. The bottle/delivery dish is twisted until the receiving bottom is in intimate contact with the aperture rim, thereby sealing the aperture of the bottle so that liquid housed therein does not escape. Once connected to the delivery dish, the bottle is then turned to said delivery dish to an inverted position. Water delivery to the delivery dish is achieved by twisting the bottle so that the seal between the aperture rim and the receiving bottle is broken so that liquid escapes from the bottle through the aperture and the watering slit and is delivered into the delivery dish.

When the desired amount of water is delivered to the delivery dish, the bottle/delivery dish is twisted until the receiving bottom is again in intimate contact with the aperture rim, thereby sealing the aperture of the bottle, thereby preventing more liquid from escaping out of the bottle. The pet is then allowed to drink from the delivery dish. After which, the bottle connected to the delivery dish is turned to the up-right position and the bottle is removed from the cap receiving member of the delivery dish. Lastly, the bottle cap is replaced back onto the top portion of the bottle, thereby sealing the aperture, and the bottle is placed within the interior compartment of the delivery dish.

### BRIEF DESCRIPTION OF THE DRAWINGS

The invention will be more fully understood and further advantages will become apparent when reference is had to the following detailed description, appended claims, and accompanying drawings, in which:

FIG. 1 is a schematic view of the Portable Water Bottle and Dish Assembly for Humans and Pets, showing the bottle housed within the interior compartment of the delivery dish;

FIG. 2 is a schematic view of an embodiment of the Portable Water Bottle and Dish Assembly for Humans and Pets shown in FIG. 1, showing the bottle housed within the interior compartment of the delivery dish wherein locking portions are provided to secure the bottle in the interior compartment of the delivery dish;

FIG. 3a is a schematic view of the bottle and the delivery dish shown in FIG. 1 in the detached configuration;

FIG. 3b is a schematic view of the bottle and delivery dish shown in FIG. 1 in the attached configuration;

FIG. 4 is a schematic view of another embodiment of the Portable Water Bottle and Dish Assembly for Humans and Pets, showing the bottle housed within the interior compartment of the delivery dish;

FIG. 5 is a schematic view of the bottle and delivery dish shown in FIG. 4 in the attached configuration illustrating the bottle pivotally removed from the interior compartment of the delivery dish; and

FIG. 6 is a schematic view of the back side of the delivery dish, illustrating the optional attachment clip for ease in transportability of the Portable Water Bottle and Dish Assembly for Humans and Pets.

### DESCRIPTION OF THE PREFERRED EMBODIMENTS

The arrangement provides for a portable water bottle and dish assembly for humans and pets. The portable water bottle and dish assembly comprises a bottle removably housed within a delivery dish. The water bottle is appointed with an attached dish that serves to protect the bottle during storage and at the same time provides a delivery means when utilized for drinking the water or liquid therein.

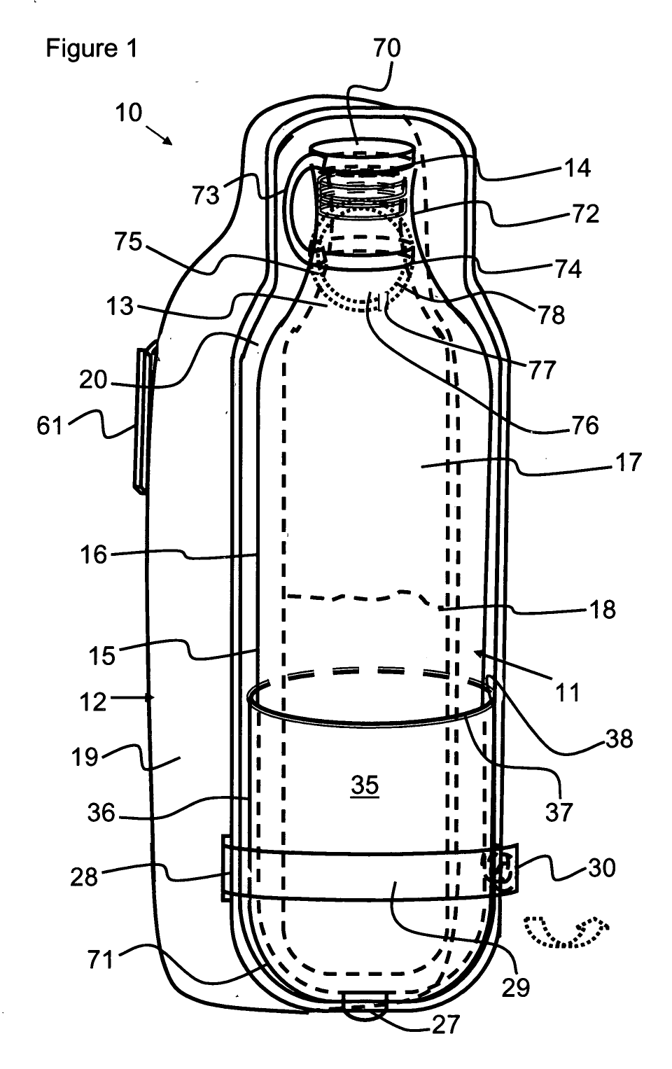

FIG. 1 is a schematic view of the Portable Water Bottle and Dish Assembly for Humans and Pets, showing the bottle housed within the interior compartment of the delivery dish, shown generally at 10. The portable water bottle and dish assembly 10 comprises a bottle 11 removably housed within a delivery dish 12. The bottle 11 includes a bottom portion 71, top portion 13 equipped with a neck 72 and an aperture 14. Bottle 11 further comprises a body portion 15 having an outer shell 16 and an internal chamber 17 appointed for receiving and housing a liquid 18 therein. The delivery dish 12 has an external casing 19 and an interior compartment 20 adapted to receive and removably house bottle 11 containing liquid 18. The top portion 13 of bottle 11 has a bottle cap 70 removably surrounding and covering aperture 14. The bottle cap 70 is adapted to seal aperture 14 of bottle 11 so liquid 18 housed therein does not escape. The bottle cap 70 is connected to neck 72 of top portion 13 of bottle 11 by way of strap 73 and collar 74 so that bottle cap 70 remains associated with bottle 11 when bottle cap 70 is removed from aperture 14. In this way, bottle cap 70 cannot be misplaced or dropped, and is readily convenient for replacement onto bottle 11.

Bottle 11 may comprise insulation means adapted to insulate liquid 18. Preferably, this is achieved by insulating internal chamber 17 of bottle 11. The internal chamber 17 of bottle 11 may be an insulating internal chamber adapted to insulate liquid 18 housed therein. In this configuration, the internal chamber 17 of bottle 11 is an insulating internal chamber and the bottle 11 acts as a thermos for keeping liquids either hot or cold for several hours, generally having a liner, usually glass, made on the principle of the Dewar vessel. The outer shell 16 of body portion 15 of bottle 11 acts to encase and encapsulate the insulating internal chamber 17, thereby protecting it. The insulating internal chamber 17 insulates liquid 18 housed therein and maintains liquid 18 at its original temperature for a period of time. Alternatively, delivery dish 12 comprises insulation means adapted to insulate liquid 18 housed in bottle 11. Interior compartment 20 of delivery dish 12 acts as an insulating interior compartment so that liquid 18 is insulated by the integral attachment of bottle 11 housed within delivery dish 12. That is to say, the insulating interior compartment 20 of delivery dish 12 acts to insulate liquid 18 housed in bottle 11 when bottle 11 is within the interior compartment 20 of delivery dish 12.

Delivery dish 12 may further comprise a fastening member 28 adapted to secure bottle 11 in interior compartment 20 of delivery dish 12 so that bottle 11 does not fall out of delivery dish 12. Fastening member 28 of delivery dish 12 may comprise a fastening strap 29 having a fastening means 30. Fastening means 30 may be selected from the group consisting of hook and clasp closure, snap closure, a loop closure, and Velcro closure. Fastening member 28 is shown herein at the base of delivery dish 12, but may be located anywhere on the external casing 19 of delivery dish 12. In addition, bottle 11 may further comprise a release tab 27 adapted to be utilized to release bottle 11 from interior compartment 20 of delivery dish 12.

Bottle cap 70 may further comprise a pour spout (not shown herein) adapted to open and close to provide access via the spout and to retain the seal of aperture 14. When the optional pour spout of bottle cap 70 is opened, liquid 18 is accessible for pouring out. Conversely, when the optional pour spout of bottle cap 70 is closed, liquid 18 does not escape out of the bottle but the seal between bottle cap 70 and aperture 14 is maintained.

In addition, an attachment clip 61 may be included in the assembly. Attachment clip 61 is located on external casing 19 of delivery dish 12 so that the assembly 10 may readily be placed on a person's waist or the like. Also, outer shell 16 of bottle 11 may further comprise a grip portion (not shown) appointed for providing comfort to the human when holding bottle 11. This grip portion may comprise a plurality of contour curves around body portion 15 of bottle 11, and can be composed of foam, sponge, plastic, or rubber material.

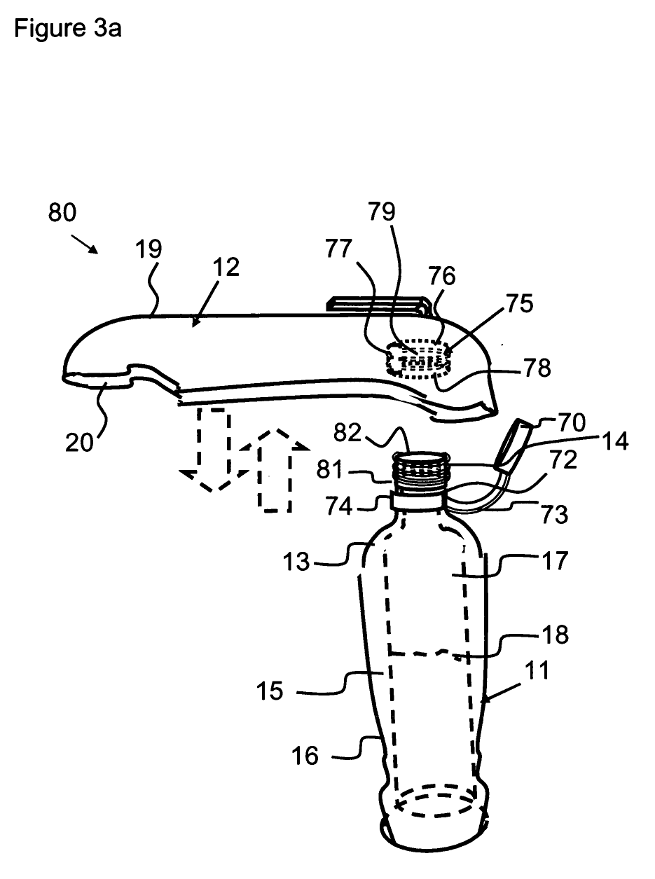

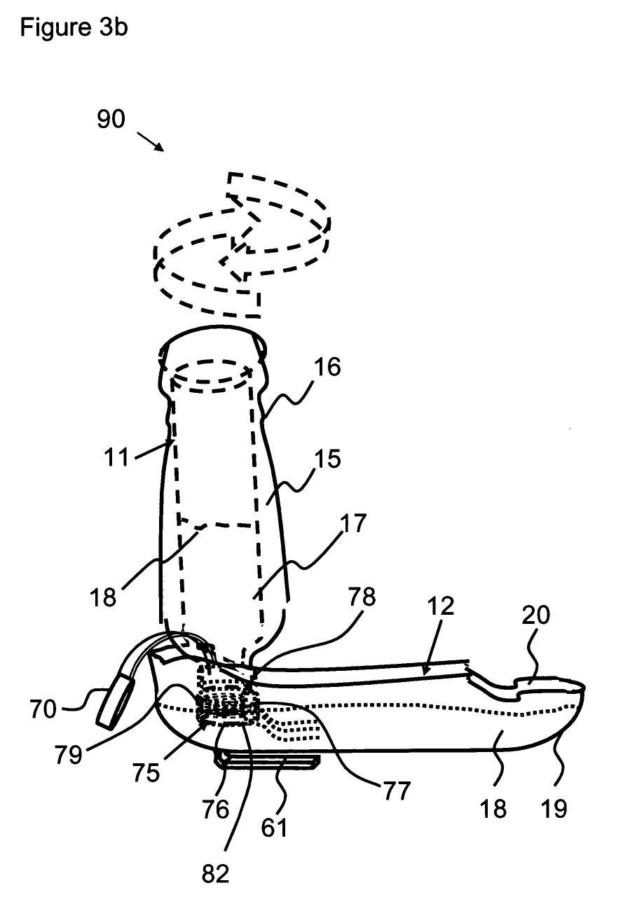

The portable water bottle and dish assembly 10 may further comprise a cup 35 having an outer surface 36, rim section 37, and a central compartment 38 adapted to receive and removably house bottom portion 71 of bottle 11. Cup 35 is adapted to receive and removably bottom portion 71 of bottle 11. When in use, cup 35 is readily removed from bottle 11 and receives and contains liquid 18 so that the pet owner/pet can drink from cup 35. Herein, bottle 11 is disposed within cup 35, and both are removably housed within delivery dish 12. Cup 35 may be composed of an insulating material so that cup 35 is adapted to insulate liquid 18. Outer surface 36 of cup 35 may include a cup grip (not shown). Interior compartment 20 of delivery dish 12 may further comprise a cap receiving member 75 (a top view is visible in FIG. 1). Cap receiving member 75 includes a receiving bottom 76, a watering slit 77, and a receiving orifice 78 (cap receiving remember 75 is discussed in further detail in FIGS. 3a and 3b herein).

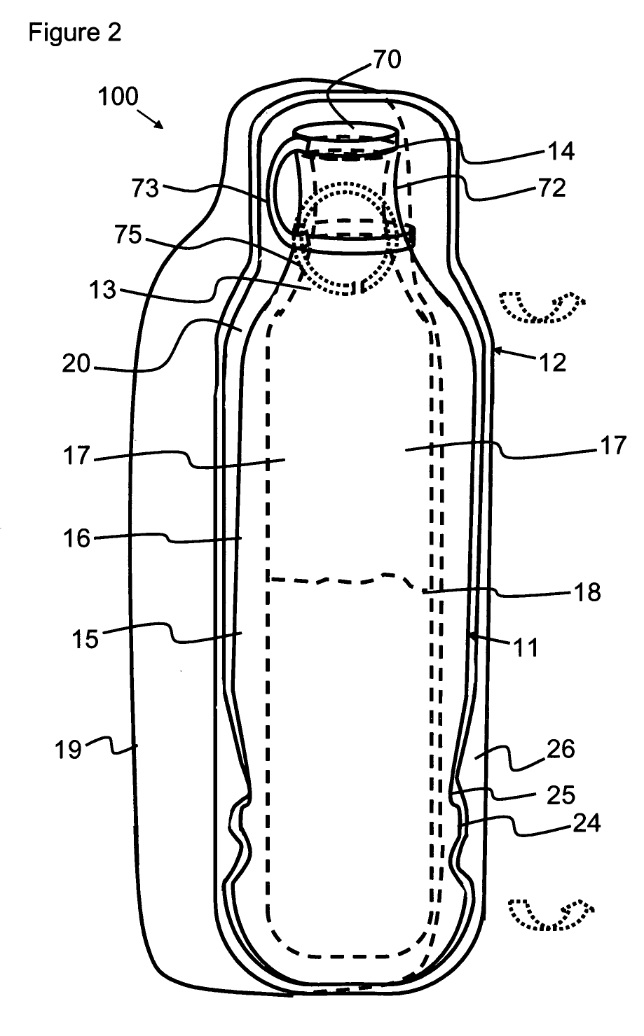

FIG. 2 is a schematic view of an embodiment of the Portable Water Bottle and Dish Assembly for Humans and Pets shown in FIG. 1, showing the bottle housed within the interior compartment of the delivery dish wherein locking portions are provided to secure the bottle in the interior compartment of the delivery dish, shown generally at 100. The body portion 15 of bottle 11 may further comprise a locking portion 24 adapted to secure bottle 11 in interior compartment 20 of delivery dish 12. Locking portion 24 comprises at least one concave locking arc 25. In this embodiment, interior compartment 20 of delivery dish 12 may further comprise at least one convex securing member 26 adapted to be received by concave locking arc 25 of body portion 15 of bottle 1. Concave locking arc 25 and convex securing member 26 act in concert to secure bottle 11 within interior compartment 20 of delivery dish 12.

FIGS. 3a and 3b are schematic views of the bottle and the delivery dish shown in FIG. 1 in the detached configuration and attached configurations. Specifically, FIG. 3a shows the detached configuration shown generally at 80, while FIG. 3b shows the attached configuration, shown generally at 90. In FIG. 3a, bottle 11 is shown detached from delivery dish 12. Bottle 11 comprises top portion 13 with an aperture 14, and body portion 15 having an outer shell 16 and an internal chamber 17 appointed for receiving and housing liquid 18 therein. Delivery dish 12 comprises external casing 19 and interior compartment 20 adapted to receive and removably house bottle 11. Interior compartment 20 of delivery dish 12 may further comprise a cap receiving member 75. Cap receiving member 75 includes a receiving bottom 76, a watering slit 77, and a receiving orifice 78. Cap receiving member 75 is adapted to removably connect to top portion 13 of bottle 11. Receiving orifice 78 has closure grooves 79 located therein. Neck 72 of top portion 13 of bottle 11 further comprises bottle top grooves 81 fixedly surrounding aperture 14. In addition, aperture 14 of bottle 11 has an aperture rim 82.

Cap closure grooves 79, located within receiving orifice 78 of cap receiving member 75, are adapted to removably receive bottle top grooves 81. Once received therein, bottle 11 and/or delivery dish 12 are oppositely rotated or twisted until receiving bottom 76 is in intimate contact with aperture rim 82, thereby sealing aperture 14 of bottle 11 so that liquid 18 housed therein does not escape. Referring to FIG. 3b, once the seal is effectuated, the assembly shown in 80 is turned/inverted to the assembly shown in 90. Liquid 18 is appointed to escape bottle 11 through aperture 14 and watering slit 77 into delivery dish 12 when receiving bottom 76 and aperture rim 82 are not in intimate contact. When the desired level of liquid 18 enters delivery dish 12, the seal is re-effectuated through twisting of bottle 11, and the assembly 90 is turned back to the up-right position to assume disassembly thereof as shown in 80.

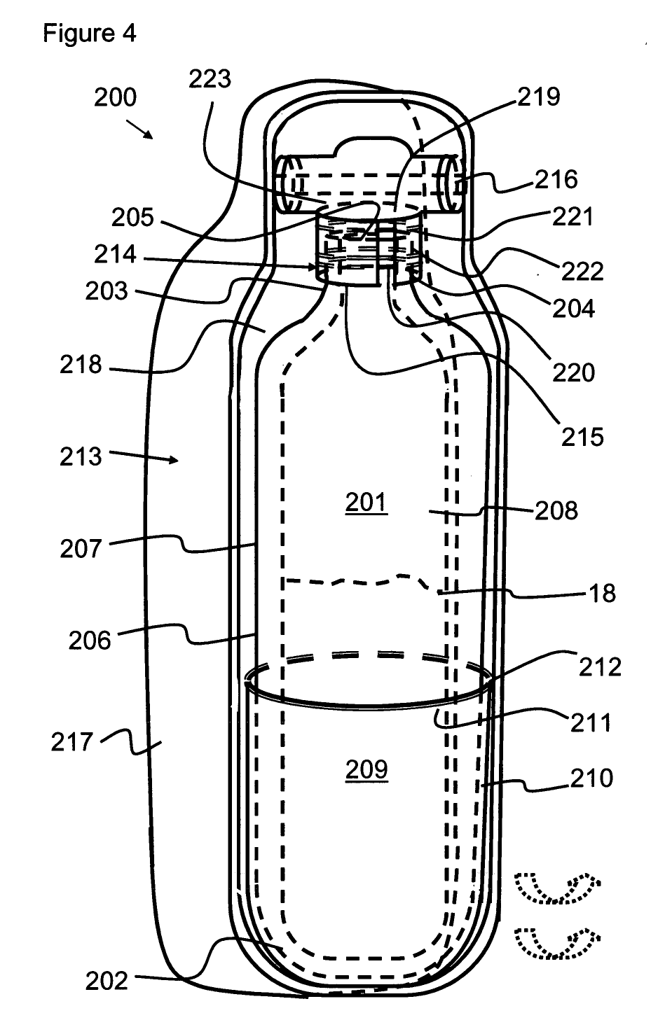

FIG. 4 is a schematic view of another embodiment of the Portable Water Bottle and Dish Assembly for Humans and Pets, showing the bottle housed within the interior compartment of the delivery dish, shown generally at 200. The portable water bottle and dish assembly for humans and pets 200 comprises a bottle 201 removably housed within a cup 209, wherein bottle 201 has insulation means. Bottle 201 comprises a bottom portion 202, a top portion 203 having a neck 204 and an aperture 205 therein, and a body portion 206. Body portion 206 has an outer shell 207 and an internal chamber 208 appointed for receiving and housing a liquid 18. Cup 209 has an outer surface 210, rim section 211, and a central compartment 212 adapted to receive and removably house bottom portion 202 of bottle 201 and further adapted to receive and contain liquid 18. An attachment clip is included (not shown). Bottle 201 is removably housed within a delivery dish 213 appointed with a cap receiving member 214 having a receiving orifice 215 pivotally connected to a pivot means 216.

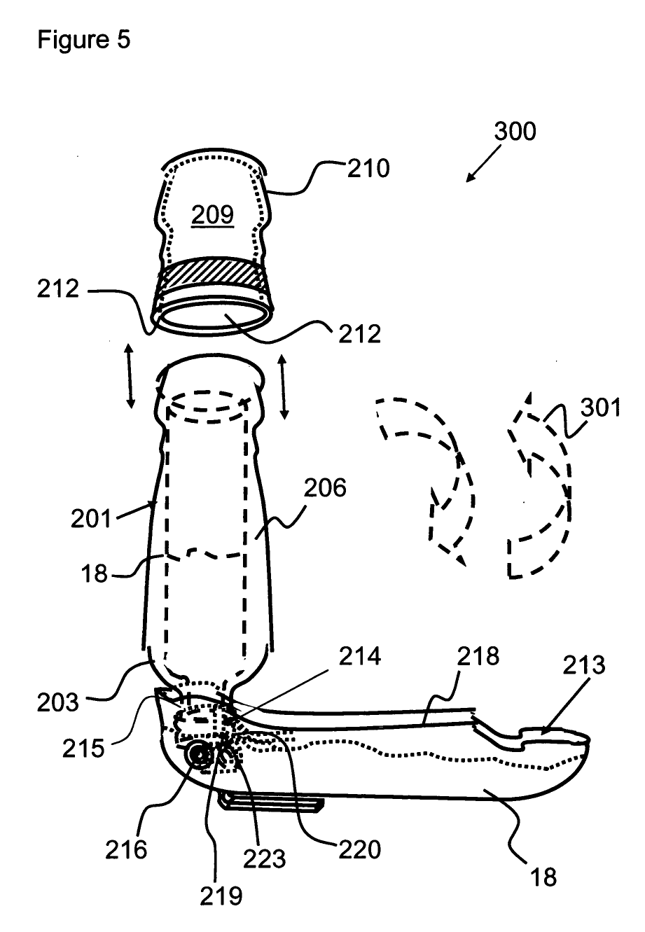

Continuing with FIG. 4, delivery dish 213 has an external casing 217 and an interior compartment 218 adapted to receive and removably house bottle 201 and further adapted to receive and contain liquid 18 so that the human and the pet can drink from delivery dish 213 after bottle 201 is removed therefrom. The interior compartment 218 of delivery dish 213 comprises cap receiving member 214. The cap receiving member 214 includes a receiving bottom 219, a watering slit 220 and receiving orifice 215 having cap closure grooves 221 located therein. Neck 204 of top portion 203 of bottle 201 further comprises bottle top grooves 222 fixedly surrounding aperture 205. Aperture 205 of bottle 201 has an aperture rim 223. Cap closure grooves 221 located within receiving orifice 215 are adapted to removably receive bottle top grooves 222 and be twisted until the receiving bottom 219 is in intimate contact with aperture rim 223 thereby sealing aperture 205 so that liquid 18 does not escape out of bottle 201. Liquid 18 is appointed to escape bottle 201 through aperture 204 and watering slit 220 into delivery dish 213 when receiving bottom 219 and aperture rim 223 are not in intimate contact. (See FIG. 5).

FIG. 5 is a schematic view of the bottle and delivery dish shown in FIG. 4 in the attached configuration illustrating the bottle pivotally removed from the interior compartment of the delivery dish, shown generally at 300. Bottle 201 pivots towards and away from delivery dish 213, depending on whether bottle 201 is being loaded into delivery dish 213, water is being delivered into the delivery dish 213, or bottle 201 is being removed from delivery dish 213. Bottle 201 is removably attached to delivery dish 213 by way of top portion 203 being integrally connected to cap receiving member 214 via receiving orifice 215 of delivery dish 213, as discussed in FIG. 4 herein above. The cap receiving member 214 is pivotally connected to pivot means 216 so that the cap receiving member 214 is adapted to rotate or pivot back in forth in an outward and inward direction as indicated by the phantom arrows 301.

Referring to FIGS. 4 and 5, cap receiving member 214 is further adapted to removably connect to top portion 203 of bottle 201 when bottle 201 is attached to delivery dish 213. After attachment, the pivot means 216 rotates cap receiving member 214 and visa vie bottle 201 so that the body portion 206 of bottle 201 is housed within interior compartment 218 of delivery dish 213. Phantom arrows 301 illustrate the pivoting or rotation motion of the assembly. The cap receiving member 214 includes a receiving bottom 219, a watering slit 220 and receiving orifice 215 having cap closure grooves 221 located therein. Neck 204 of top portion 203 of bottle 201 further comprises bottle top grooves 222 fixedly surrounding aperture 205. Aperture 205 of bottle 201 has an aperture rim 223. Cap closure grooves 221 located within receiving orifice 215 are adapted to removably receive bottle top grooves 222 and be twisted until the receiving bottom 219 is in intimate contact with aperture rim 223 thereby sealing aperture 205 so that liquid 18 does not escape out of bottle 201. Liquid 18 is appointed to escape bottle 201 through aperture 204 and watering slit 220 into delivery dish 213 when receiving bottom 219 and aperture rim 223 are not in intimate contact.

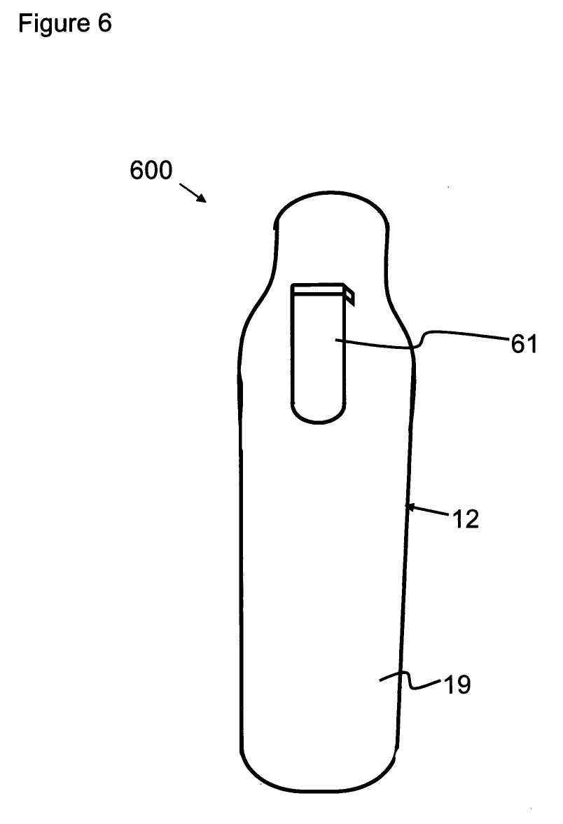

FIG. 6 is a schematic view of the back side of the delivery dish, illustrating the optional attachment clip for ease in transportability of the Portable Water Bottle and Dish Assembly for Humans and Pets, shown generally at 600. An attachment clip 61 may be included in the assembly. The attachment clip 61 is located on the external casing 19 of delivery dish 12.

In another embodiment, the portable water bottle and dish assembly for humans and pets comprises a bottle removably housed within a cup, wherein the bottle has insulation means. The bottle comprises a bottom portion, a top portion having a neck and an aperture therein, and a body portion having an outer shell and an internal chamber appointed for receiving and housing a liquid. A cup is provided. The cup has an outer surface, rim section, and a central compartment adapted to receive and removably house the bottom portion of the bottle and further adapted to receive and contain the liquid. An attachment clip is included. The attachment clip is located on the outer shell of the bottle. The top portion of the bottle is appointed with a bottle cap that removably surrounds the aperture and is adapted to seal the aperture of the bottle so that liquid housed therein does not escape.

The present invention also provides a method of delivering water by way of a portable water bottle and dish assembly to a pet or human. Please refer to FIGS. 1, 3a and 3b for clarity. The method includes the first step of filling a bottle with a liquid, wherein the bottle comprises insulation means adapted to insulate the liquid and comprises a bottom portion and a top portion having a neck, an aperture, and a body portion having an outer shell and an internal chamber appointed for receiving and housing a liquid therein. The neck has bottle top grooves fixedly surrounding the aperture, and the aperture of the bottle has an aperture rim. A bottle cap is then placed on the top portion of the bottle. The bottle cap removably surrounds the aperture and is adapted to seal the aperture of the bottle so that the liquid housed therein does not escape. The bottle cap is connected to the neck of the top portion so that the bottle cap remains associated with the bottle when the bottle cap is removed from the aperture. The bottle appointed with the bottle cap is placed within an interior compartment of a delivery dish having a cap receiving member with a receiving bottom, a watering slit and a receiving orifice having cap closure grooves located therein.

The delivery dish, with the bottle containing the liquid housed therein, is then carried until the pet or human experience thirst. The bottle is then removed from the interior compartment of the delivery dish, and, while the bottle is in an up-right position, the bottle cap is removed. The top portion of the bottle is placed within the receiving orifice of the cap receiving member of the interior compartment of the delivery dish so that the bottle top grooves and the cap closure grooves are in intimate contact and can be twisted together to unite the bottle with the delivery dish. The bottle/delivery dish is twisted until the receiving bottom is in intimate contact with the aperture rim, thereby sealing the aperture of the bottle so that liquid housed therein does not escape. Once connected to the delivery dish, the bottle is then turned to said delivery dish to an inverted position. Water delivery to the delivery dish is achieved by twisting the bottle so that the seal between the aperture rim and the receiving bottle is broken so that liquid escapes from the bottle through the aperture and the watering slit and is delivered into the delivery dish.

When the desired amount of water is delivered to the delivery dish, the bottle/delivery dish is twisted until the receiving bottom is again in intimate contact with the aperture rim, thereby sealing the aperture of the bottle, thereby preventing more liquid from escaping out of the bottle. The pet is then allowed to drink from the delivery dish. After which, the bottle connected to the delivery dish is turned to the up-right position and the bottle is removed from the cap receiving member of the delivery dish. Lastly, the bottle cap is replaced back onto the top portion of the bottle, thereby sealing the aperture, and the bottle is placed within the interior compartment of the delivery dish.

The delivery dish 12 can be in an array of shapes and sizes, in conformance with the bottle's 11 shape and size. The delivery dish 12 closes over bottle 11 for compact storage, comfort, and for use when the liquid 18 housed within the bottle 11 is being consumed. The delivery dish 12 is removed from the bottle 11 when the bottle 11 is opened, as the delivery dish 12 is integrally attached to the bottle 11 at a top portion 13 via cap receiving portion 21. The delivery dish 12 may be removed for cleaning, or when in use, for delivering the liquid 18 to a human or pet.

The delivery dish 12 is composed of a light weight, durable plastic or metal material; preferably plastic or light weight stainless steel. The cap receiving portion 21 of delivery dish 12 removably houses a top portion 13 of bottle 11 and is also composed of a lightweight, durable plastic or metal material; preferably plastic or light weight stainless steel. The color, as well as the size, of the delivery dish 12 may vary. Optionally, the bottle 11 may be contoured to ergonomically mirror the human hand in order to facilitate a better grip. Furthermore, the contoured grip feature may have a foam or rubber surface in order to facilitate a better grip. Alternatively, the delivery dish 12 is an insulated delivery dish comprising a lined interior made on the principle of the Dewar vessel for keeping liquids either hot or cold for several hours. The non-insulated bottle or the bottle 11 can be placed within the interior compartment 20 of the insulated delivery dish 12.

Having thus described the invention in rather full detail, it will be understood that such detail need not be strictly adhered to but that various changes and modifications may suggest themselves to one skilled in the art. For example, the bottle 11 with which bottle cap 70, strap 73 and collar 74 are associated, can be a beverage containing bottle, such as a standard soda bottle, or a bottle containing carbonated or noncarbonated water. With such bottles it is especially advantageous if the collar 74 and strap 73 cooperate with bottle cap 70 to maintain the cap in close association with the bottle even when the bottle cap is removed from aperture 14. It would also be advantageous if cap 70 were provided with a tamper-proof feature, such as a plastic strip integrally connecting cap 70 to a shroud or sleeve disposed around the bottle neck at a locus directly beneath the cap. With this embodiment, cap 70 is securely held in position over aperture 14, despite pressure within bottle 11 attributed to carbonation of liquid therein. The tamper-proof cap 70 is conveniently removed by tearing the plastic strip in a circular direction along the upper perimeter of the bottle neck. Such changes and modifications are intended to fall within the scope of the invention as defined by the subjoined claims.

What is claimed is:

1. A portable water bottle and dish assembly for humans and pets, comprising:
a. a bottle removably housed within a delivery dish;
b. said bottle comprising a bottom portion, a top portion having a neck and an aperture therein, and a body portion having an outer shell and an internal chamber appointed for receiving and housing a liquid;
c. said delivery dish having an external casing and an interior compartment adapted to receive and removably house said bottle and further adapted to receive and contain said liquid so that said human and said pet can drink from said delivery dish after said bottle is removed therefrom;
d. said top portion of said bottle having a bottle cap removably surrounding said aperture and being adapted to seal said aperture of said bottle so that said liquid housed therein does not escape out of said bottle, said bottle cap being connected to said neck of said top portion so that said bottle cap remains associated with said bottle when said bottle cap is removed from said aperture.

2. A portable water bottle and dish assembly as recited by claim 1, wherein said bottle comprises insulation means adapted to insulate said liquid.

3. A portable water bottle and dish assembly as recited by claim 1, wherein said delivery dish comprises insulation means adapted to insulate said liquid housed in said bottle when said bottle is within said interior compartment of said delivery dish.

4. A portable water bottle and dish assembly as recited by claim 1, wherein said body portion of said bottle further comprises a locking portion adapted to secure said bottle in said interior compartment of said delivery dish, said locking portion comprises at least one concave locking arc.

5. A portable water bottle and dish assembly as recited by claim 1, wherein said interior compartment of said delivery dish further comprises at least one convex securing member adapted to be received by said concave locking arc of said body portion of said bottle acting in concert to secure said bottle within said interior compartment of said delivery dish.

6. A portable water bottle and dish assembly as recited by claim 1, wherein said delivery dish further comprises a fastening member adapted to secure said bottle in said interior compartment of said delivery dish.

7. A portable water bottle and dish assembly as recited by claim 6, wherein said fastening member of said delivery dish comprises a fastening strap having a fastening means.

8. A portable water bottle and dish assembly as recited by claim 7, wherein said fastening means is selected from the group consisting of hook and clasp closure, snap closure, loop closure, and Velcro closure.

9. A portable water bottle and dish assembly as recited by claim 1, wherein said body portion of said bottle further comprises a release tab adapted to be utilized to release said body portion of said bottle from said interior compartment of said delivery dish.

10. A portable water bottle and dish assembly as recited by claim 1, wherein said bottle cap further comprises a pour spout being adapted to open and close to access and seal said aperture of said bottle so that said liquid housed therein is accessible when said pour spout is open and said liquid does not escape out of said bottle when said pour spout is closed.

11. A portable water bottle and dish assembly as recited by claim 1, wherein said interior compartment of said delivery dish comprises a cap receiving member having a receiving bottom, a watering slit and a receiving orifice having closure grooves located therein, wherein said neck of said top portion of said bottle further comprises bottle top grooves fixedly surrounding said aperture and said aperture of said bottle has an aperture rim, said cap closure grooves located within said receiving orifice being adapted to removably receive said bottle top grooves and be twisted until said receiving bottom is in intimate contact with said aperture rim thereby sealing said aperture of said bottle so that said liquid housed therein does not escape out of said bottle, and wherein said liquid is appointed to escape said bottle through said aperture and said watering slit into said delivery dish when said receiving bottom and said aperture rim are not in intimate contact.

12. A portable water bottle and dish assembly as recited by claim 1 comprising an attachment clip located on said external casing of said delivery dish.

13. A portable water bottle and dish assembly as recited by claim 1, wherein said outer shell of said bottle further comprises a grip portion.

14. A portable water bottle and dish assembly as recited by claim 13, wherein said grip portion comprises a plurality of contour curves.

15. A portable water bottle and dish assembly as recited by claim 13, wherein said grip portion is composed of foam, sponge, plastic, or rubber material.

16. A portable water bottle and dish assembly as recited by claim 1 comprising a cup having an outer surface, rim section, and a central compartment adapted to receive and removably house said bottom portion of said bottle and further adapted to receive and contain said liquid so that said human can drink therefrom, said bottle being disposed within said cup and both being removably housed within said delivery dish.

17. A portable water bottle and dish assembly as recited by claim 16, wherein said cup is composed of an insulating material so that said cup is adapted to insulate said liquid.

18. A portable water bottle, cup and dish assembly as recited by claim 16, wherein said outer surface of said cup includes a cup grip.

19. A portable water bottle and dish assembly for humans and pets, comprising:
a. a bottle removably housed within a delivery dish;
b. said bottle comprising a bottom portion, a top portion having a neck and an aperture therein, and a body portion having an outer shell and an internal chamber appointed for receiving and housing a liquid;
c. said delivery dish having an external casing and an interior compartment adapted to receive and removably house said bottle and further adapted to receive and contain said liquid so that said human and said pet can drink from said delivery dish after said bottle is removed therefrom;
d. said interior compartment of said delivery dish comprising a cap receiving member having a receiving orifice pivotally connected to a pivot means; and
e. said cap receiving member having a receiving bottom, a watering slit and a receiving orifice having cap closure grooves located therein, wherein said neck of said top portion of said bottle further comprises bottle top grooves fixedly surrounding said aperture and said aperture of said bottle has an aperture rim, said cap closure grooves located within said receiving orifice being adapted to removably receive said bottle top grooves and be twisted until said receiving bottom is in intimate contact with said aperture rim thereby sealing said aperture of said bottle so that said liquid housed therein does not escape out of said bottle, and wherein said liquid is appointed to escape said bottle through said aperture and said watering slit into said delivery dish when said receiving bottom and said aperture rim are not in intimate contact.

20. A portable water bottle and dish assembly as recited by claim 19, wherein said bottle comprises insulation means adapted to insulate said liquid.

21. A portable water bottle and dish assembly as recited by claim 19, wherein said delivery dish comprises insulation means adapted to insulate said liquid.

22. A portable water bottle and dish assembly as recited by claim 19 comprising an attachment clip located on said external casing of said delivery dish.

23. A portable water bottle and dish assembly as recited by claim 19 comprising a cup having an outer surface, rim section, and a central compartment adapted to receive and removably house said bottom portion of said bottle and further adapted to receive and contain said liquid so that said human can drink therefrom, said bottle being disposed within said cup and both being removably housed within said delivery dish.

24. A portable water bottle and dish assembly as recited by claim 23 wherein said cup is composed of an insulating material so that said cup is adapted to insulate said liquid.

25. A portable water bottle and dish assembly for humans and pets, comprising:
a. a bottle removably housed within a cup, said bottle having insulation means;
b. said bottle comprising a bottom portion, a top portion having a neck and an aperture therein, and a body portion having an outer shell and an internal chamber appointed for receiving and housing a liquid;
c. said cup having an outer surface, rim section, and a central compartment adapted to receive and removably house said bottom portion of said bottle and further adapted to receive and contain said liquid;
d. an attachment clip located on said outer shell of said bottle; and
e. said top portion of said bottle having a bottle cap removably surrounding said aperture and being adapted to seal said aperture of said bottle so that said liquid housed therein does not escape.

26. A method of delivering water by way of a portable water bottle and dish assembly to a pet or human, comprising the steps of:
a. filling a bottle with a liquid, said bottle comprises insulation means adapted to insulate said liquid and comprising a bottom portion and a top portion having a neck, an aperture, and a body portion having an outer shell and an internal chamber appointed for receiving and housing a liquid therein, said neck having bottle top grooves fixedly surrounding said aperture, and wherein said aperture of said bottle has an aperture rim.
b. placing a bottle cap on said top portion of said bottle, said bottle cap removably surrounding said aperture and being adapted to seal said aperture of said bottle so that said liquid housed therein does not escape out of said bottle, said bottle cap being connected to said neck of said top portion so that said bottle cap remains associated with said bottle when said bottle cap is removed from said aperture;
c. placing said bottle appointed with said bottle cap in an interior compartment of a delivery dish having a cap receiving member with a receiving bottom, a watering slit and a receiving orifice having cap closure grooves located therein;
d. carrying said delivery dish with said bottle containing said liquid housed therein until said pet or human experiences thirst;
e. removing said bottle from said interior compartment of said delivery dish;
f. removing said bottle cap from said top portion of said bottle, and keeping said bottle in an up-right position;
g. placing said top portion of said bottle within said receiving orifice of said cap receiving member of said interior compartment of said delivery dish so that said bottle top grooves and said cap closure grooves are in intimate contact and can be twisted together to unite said bottle with said delivery dish;
h. twisting said bottle until said receiving bottom is in intimate contact with said aperture rim thereby sealing said aperture of said bottle so that said liquid housed therein does not escape out of said bottle;
i. turning said bottle connected to said delivery dish to an inverted position and twisting said bottle so that said seal between said aperture rim and said receiving bottle is broken so that said liquid escapes from said bottle through said aperture and said watering slit and is delivered into said delivery dish;
j. twisting said twisting said bottle until said receiving bottom is in intimate contact with said aperture rim thereby sealing said aperture of said bottle when a desired amount of said liquid is received within said delivery dish, thereby preventing more of said liquid from escaping out of said bottle;
k. allowing said pet to drink from said delivery dish;
l. turning said bottle connected to said delivery dish to said up-right position;
m. removing said bottle from said cap receiving member of said delivery dish; and
n. replacing said bottle cap onto said top portion of said bottle and placing said bottle within said interior compartment of said delivery dish.

27. A portable beverage containing bottle assembly, comprising:
a. a bottle comprising a bottom portion, a top portion having a neck and an aperture therein, and a body portion having an outer surface and an internal chamber appointed for receiving and housing a liquid;
b. said top portion of said bottle having a bottle cap removably surrounding said aperture and being adapted to seal said aperture of said bottle so that said liquid housed therein does not escape out of said bottle, said bottle cap being connected to said neck of said top portion so that said bottle cap remains associated with said bottle when said bottle cap is removed from said aperture.

28. A portable beverage containing bottle assembly as recited by claim 27, wherein said cap is integrally connected to a shroud disposed around said neck at a locus directly beneath said cap, whereby said cap is securely held in position over said aperture.

29. A portable beverage containing bottle assembly as recited by claim 28, wherein said cap and said shroud are integrally connected by a plastic strip, and said cap is removed from said aperture by tearing the plastic strip in a circular direction along an upper perimeter of said bottle neck.
